(19) United States
(12) Patent Application Publication
(10) Pub. No.: US 2016/0031322 A1
(43) Pub. Date: Feb. 4, 2016

(54) BRACKET FOR SECURING TO A PANEL

(71) Applicant: Caterpillar Inc., Peoria, IL (US)

(72) Inventors: Nilesh A. Sutar, Peoria, IL (US); Kevin L. Welty, Washington, IL (US); Benjamin M. Franzen, Peoria, IL (US)

(73) Assignee: Caterpillar Inc., Peoria, IL (US)

(21) Appl. No.: 14/450,581

(22) Filed: Aug. 4, 2014

(51) Int. Cl. B60K 37/00; B21D 53/88; B23P 19/04; F16M 13/02; B62D 65/14

(52) U.S. Cl. CPC B60K 37/00; F16M 13/02; B62D 65/14; B23P 19/04; B21D 53/88

(57) ABSTRACT

A bracket for securing to a panel includes a first leg, a second leg, and a third leg. The first leg has a proximal end and a distal end, and the distal end is configured to be received in a socket of the panel. The second leg is connected with the first leg and the third leg. The third leg extends generally opposed from the first leg, and includes a first notch surface and a second notch surface. The first notch surface is configured to be in contacting relationship with an outer surface of the panel, and the second notch surface is configured to be in contacting relationship with a front surface of the panel.

### TECHNICAL FIELD

The present disclosure is directed to a bracket for securing to a panel, and a related assembly and method.

### BACKGROUND

Brackets can be used to support or secure a structure. For example, and in the context of a machine or vehicle that includes a cab area where an operator rides, an instrument panel can be secured to an underlying structural component using one or more brackets.

U.S. Pub. No. 2013/0312242 discloses an installation fixture or jig for temporarily supporting an instrument panel module when the instrument panel module is installed in a vehicle. The installation fixture must be secured to the instrument panel module before each installation, and removed after each installation, however. Moreover, the installation fixture must be consistently positioned relative to the instrument panel module and the vehicle in order for the instrument panel module to be repeatedly installed in the same position of the vehicle.

The present disclosure is directed at solving one or more of the problems set forth above and/or other problems in the art.

### SUMMARY OF THE INVENTION

In an embodiment, a bracket is provided for securing to a panel having an outer surface, an inner surface generally opposed from the outer surface, a front surface connecting the outer surface and the inner surface, and a socket. The bracket includes a first leg having a proximal end and a distal end. The distal end is configured to be received in the socket of the panel to limit movement of the bracket with respect to the panel in a first direction. The bracket further includes a second leg connected with the first leg. The bracket further includes a third leg connected with the second leg and extending generally opposed from the first leg. The third leg also includes a first notch surface and a second notch surface. The first notch surface is configured to be in contacting relationship with the outer surface of the panel to limit movement of the bracket with respect to the panel in a second direction different from the first direction. The second notch surface is configured to be in contacting relationship with the front surface of the panel to limit movement of the bracket with respect to the panel in a third direction different from the first direction and the second direction.

In another embodiment, an assembly is provided and includes a panel and a bracket secured to the panel. The panel includes an outer surface, an inner surface generally opposed from the outer surface, a front surface connecting the outer surface and the inner surface, and a socket. The bracket includes a first leg, a second leg, and a third leg. The first leg has a proximal end and a distal end, and the distal end is received in the socket of the panel and limits movement of the bracket with respect to the panel in a first direction. The second leg is connected with the first leg. The third leg is connected with the second leg and extends generally opposed from the first leg. The third leg includes a first notch surface and a second notch surface. The first notch surface is in contacting relationship with the outer surface of the panel and limits movement of the bracket with respect to the panel in a second direction different from the first direction. The second notch surface is in contacting relationship with the front surface of the panel and limits movement of the bracket with respect to the panel in a third direction different from the first direction and the second direction.

In another embodiment, a method is provided for securing a three-legged bracket to a panel having an outer surface, an inner surface generally opposed from the outer surface, a front surface connecting the outer surface and the inner surface, and a socket. The method includes positioning a distal end of a first leg of the bracket in the socket of the panel, and positioning a second leg of the bracket in facing relationship with the front surface of the panel. The method further includes positioning a first notch surface of a third leg of the bracket in contacting relationship with the outer surface of the panel, and positioning a second notch surface of the third leg of the bracket in contacting relationship with the front surface of the panel.

### BRIEF DESCRIPTION OF THE DRAWINGS

FIG. 1 is a side view of a machine.

FIG. 2 is a view showing the inside of a cab assembly of the machine of FIG. 1.

FIG. 3 shows instrument panels within the cab assembly secured to panels of a steering column enclosure assembly.

FIG. 4 shows first and second panels of the steering column enclosure assembly of FIG. 3.

FIG. 5 shows a bracket that is secured to the panels of FIG. 4.

FIGS. 6 and 7 are side views of the bracket of FIG. 5.

FIGS. 8 and 9 are front and rear views, respectively, of the bracket of FIG. 5.

FIGS. 10 and 11 are top and bottom views, respectively, of the bracket of FIG. 5.

FIGS. 12A and 12B show a bracket secured to the first panel of the steering column enclosure assembly.

FIGS. 13A and 13B show a bracket secured to the second panel of the steering column enclosure assembly.

### DETAILED DESCRIPTION

This disclosure describes a bracket that can be secured to a panel, an assembly including a bracket and a panel, and a related method of securing a bracket to a panel. The bracket is generally configured to cooperate with surfaces of a panel and a socket formed in the panel. Generally, one leg of the bracket is received in the socket of the panel, while another leg of the bracket contacts two surfaces of the panel. Advantageously, the bracket can be secured to a panel without requiring an additional fixture for holding the bracket. Once the bracket is secured to the panel, another component can be secured to the bracket, such as an instrument panel.

The bracket and method described in this disclosure are generally applicable for securing to a wide range of panels. In order to illustrate the principles of this disclosure, the figures depict and the following text describes the bracket in association with panels of a steering column enclosure assembly inside of a cab assembly of a machine. It will be appreciated, however, that the principles of this disclosure may be applicable to other types and configurations of panels, as well.

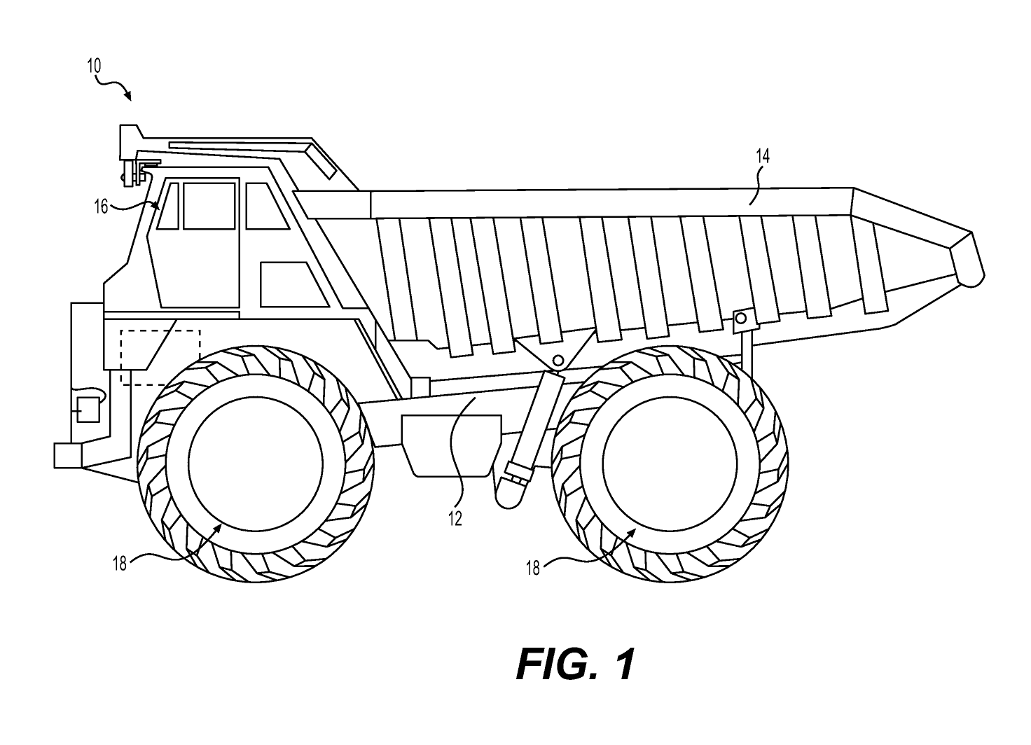

Referring to the figures and beginning with FIG. 1, a machine 10 in the form of a mining truck is shown and generally includes a frame 12, a body 14, a cab assembly 16, and a set of four ground engaging members 18. The body 14 is configured to receive a load of material, such as coal, metal ores, or overburden from a mine site. The machine 10 also includes a hoist system (not shown) for hoisting the body 14 relative to the frame 12 in order to dump the load of material out of the body 14, as is generally known.

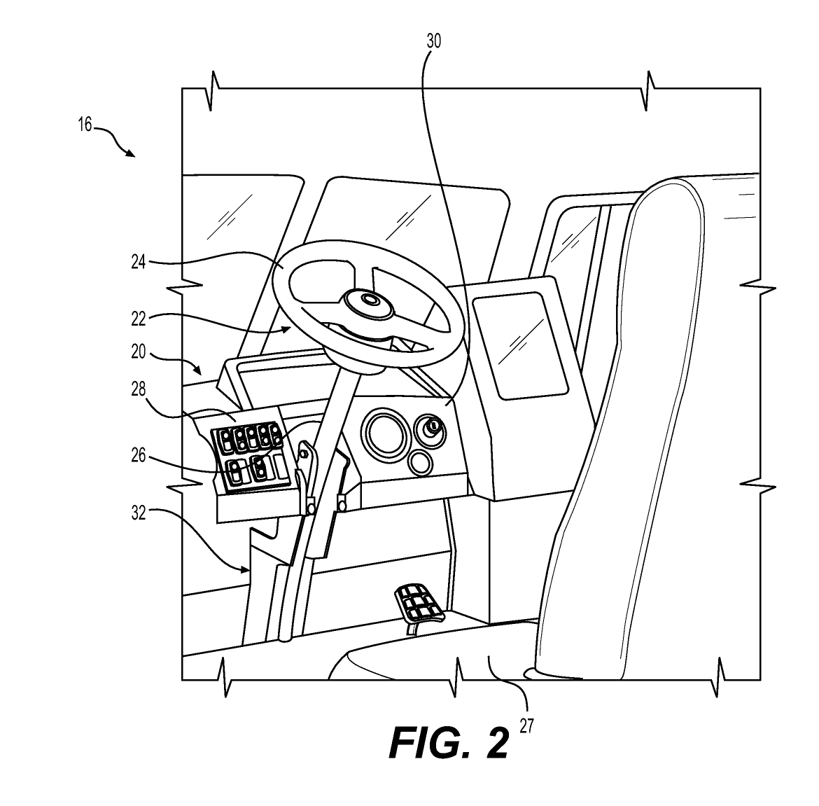

Referring next to FIG. 2, the cab assembly 16 houses machine controls 20, including a steering assembly 22. In the embodiment shown, the steering assembly 22 includes a steering wheel 24, and a steering column 26, which are operatively connected with the components for steering the machine's ground engaging members 18. A seat 27 is provided for positioning an operator close to the machine controls 20, including the steering wheel 24. Thereby, an operator can sit on the seat 27 and operate the machine 10 using the machine controls 20.

A first instrument panel 28 is located generally to one side (the left side) of the steering column 26 and below the steering wheel 24. A second instrument panel 30 is located generally on the other side (the right side) of the steering column 26 and is also below the steering wheel 24. The first and second instrument panels 28, 30 can include one or more of the machine controls 20, and are positioned to be accessed by an operator inside the cab assembly 16. The first and second instrument panels 28, 30 can also conceal various components which do not need to be accessed by the operator during normal operation of the machine 10 (such as electrical wiring, air ventilation ducts, and the like). Optionally, the first and second instrument panels 28, 30 may be joined together in a unitary instrument panel that extends on beoth the left and right sides of the steering column 26.

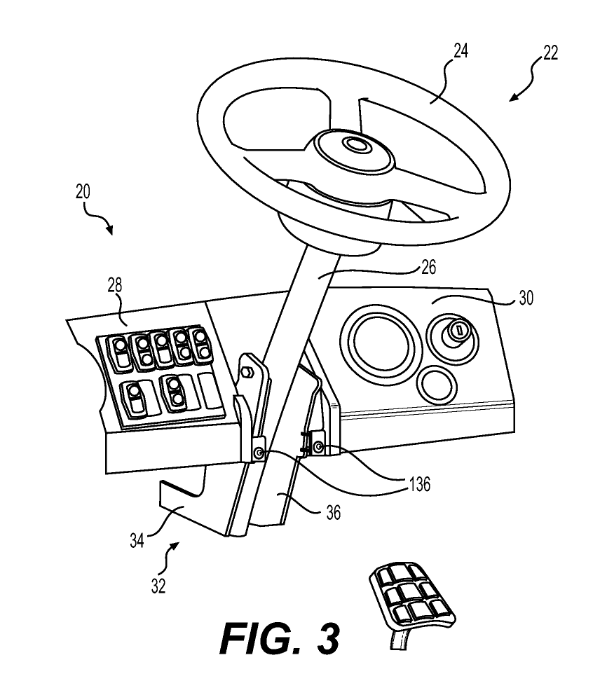

Referring next to FIG. 3, the first and second instrument panels 28, 30 are shown secured to a steering column enclosure assembly 32. The steering column enclosure assembly 32 includes a first enclosure panel 34 located generally to one side (the left side) of the steering column 26, and a second enclosure panel 36 located generally on the other side (the right side) of the steering column 26. The first instrument panel 28 is secured to the first enclosure panel 34, and the second instrument panel 30 is secured to the second enclosure panel 36. In particular, the first and second instrument panels 28, 30 are each secured to the respective first and second enclosure panels 34, 36 via a bracket 38, which will be described in further detail below after a description of the first and second enclosure panels 34, 36.

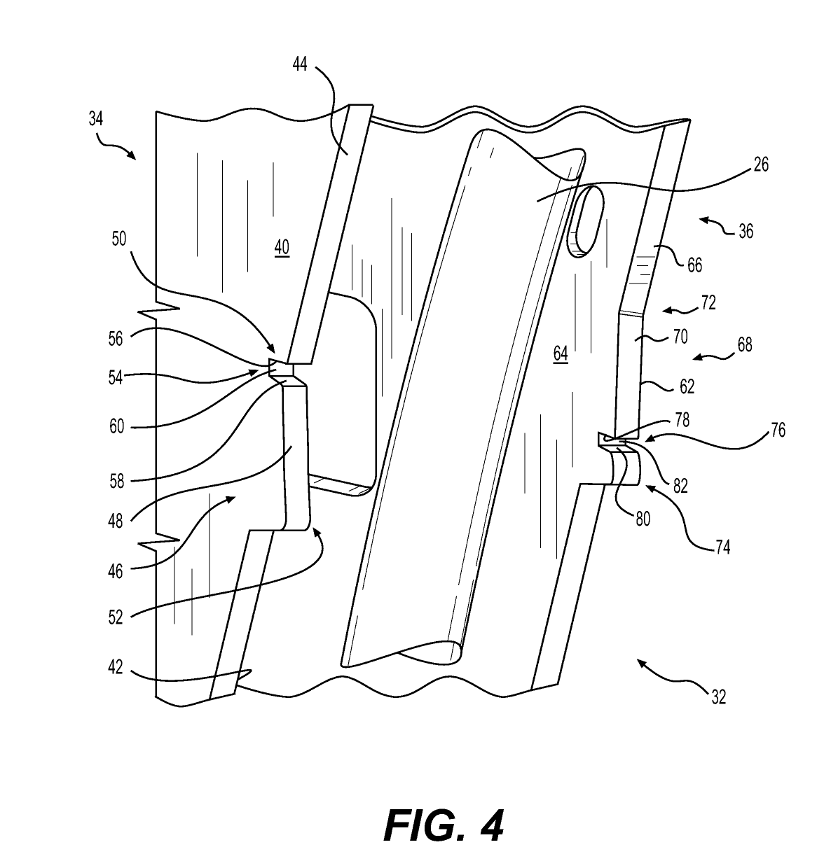

As shown in FIG. 4, the first and second enclosure panels 34, 36 extend upwardly along a portion of the length of the steering column 26. Optionally, the first and second enclosure panels 34, 36 may be joined together as part of a unitary enclosure member. The first enclosure panel 34 includes an outer surface 40, an inner surface 42 generally opposed from the outer surface 40, and a front surface 44. The front surface 44 connects the outer surface 40 and the inner surface 42. The inner surface 42 faces generally toward the steering column 26, while the outer surface 40 faces generally away from the steering column 26. The outer surface 40 and the inner surface 42 are generally parallel with each other, and both are generally perpendicular with the front surface 44. The front surface 44 presents only a narrow width between the outer surface 40 and the inner surface 42.

The first enclosure panel 34 includes a mounting portion 46 where a bracket 38 is secured to the first enclosure panel 34. The mounting portion 46 includes a generally planar segment 48 of the front surface 44. The planar segment 48 extends between a first end 50 and a second end 52. As shown, the first end 50 is vertically above the second end 52.

The mounting portion 46 also includes a socket 54 formed in the first enclosure panel 34. In particular, the socket 54 is located generally near the first end 50 of the planar segment 48. In the embodiment shown, the socket 54 is defined by three socket surfaces: (1) a first socket surface 56 that extends rearwardly from the front surface 44, (2) a second socket surface 58 that also extends rearwardly from the front surface 44, and (3) a third socket surface 60 that connects the first and second socket surfaces 56, 58 at the back of the socket 54. The first and second socket surfaces 56, 58 are generally parallel with each other, and both are generally perpendicular with the third socket surface 60 and the planar segment 48 of the front surface 44.

The second enclosure panel 36 includes an outer surface 62, an inner surface 64 generally opposed from the outer surface 62, and a front surface 66. The front surface 66 connects the outer surface 62 and the inner surface 64. The inner surface 64 faces generally toward the steering column 26, while the outer surface 62 faces generally away from the steering column 26. The outer surface 62 and the inner surface 64 are generally parallel with each other, and both are generally perpendicular with the front surface 66. The front surface 66 presents only a narrow width between the outer surface 62 and the inner surface 64.

The second enclosure panel 36 includes a mounting portion 68 where a bracket 38 is secured to the second enclosure panel 36. The mounting portion 68 includes a generally planar segment 70 of the front surface 66. The planar segment 70 extends between a first end 72 and a second end 74. As shown, the first end 72 is vertically above the second end 74.

The mounting portion 68 also includes a socket 76 formed in the second enclosure panel 36. In particular, the socket 76 is located generally near the second end 74 of the planar segment 70. In the embodiment shown, the socket 76 is defined by three socket surfaces: (1) a first socket surface 78 that extends rearwardly from the front surface 66, (2) a second socket surface 80 that also extends rearwardly from the front surface 66, and (3) a third socket surface 82 that connects the first and second socket surfaces 78, 80 at the back of the socket 76. The first and second socket surfaces 78, 80 are generally parallel with each other, and both are generally perpendicular with the third socket surface 82 and the planar segment 70 of the front surface 66.

As shown in FIG. 4, the mounting portions 46, 68 of the respective first and second enclosure panels 34, 36 have the sockets 54, 76 in slightly different locations. As will be evident from the following discussion, brackets 38 can be secured to both the first and second enclosure panels 34, 36, with the different locations of the mounting portions 46, 68 accommodating different orientations of the brackets 38. In particular, one of the brackets 38 is oriented so the first leg 84 is above the third leg 88, while the other bracket 38 is oriented so the third leg 88 is above the first leg 84. Advantageously, the sockets 54, 76 provide positions for locating respective brackets 38. Thereby, brackets 38 can be repeatedly placed in the same relative positions to the first and second enclosure panels 34, 36.

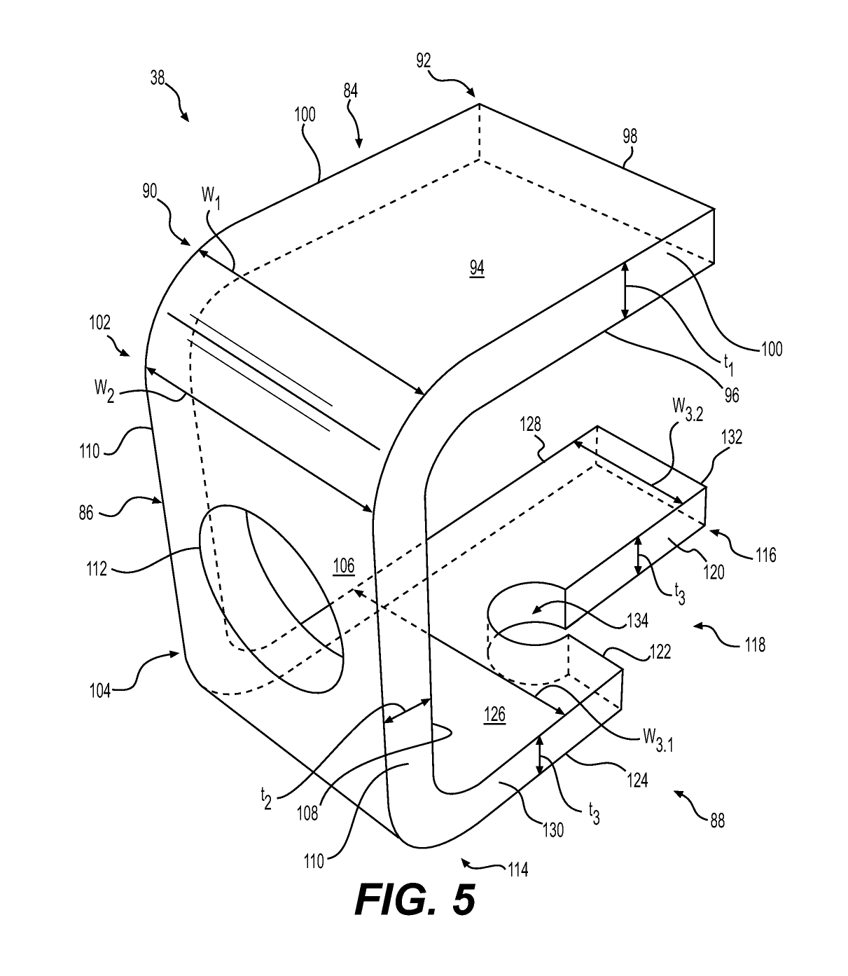

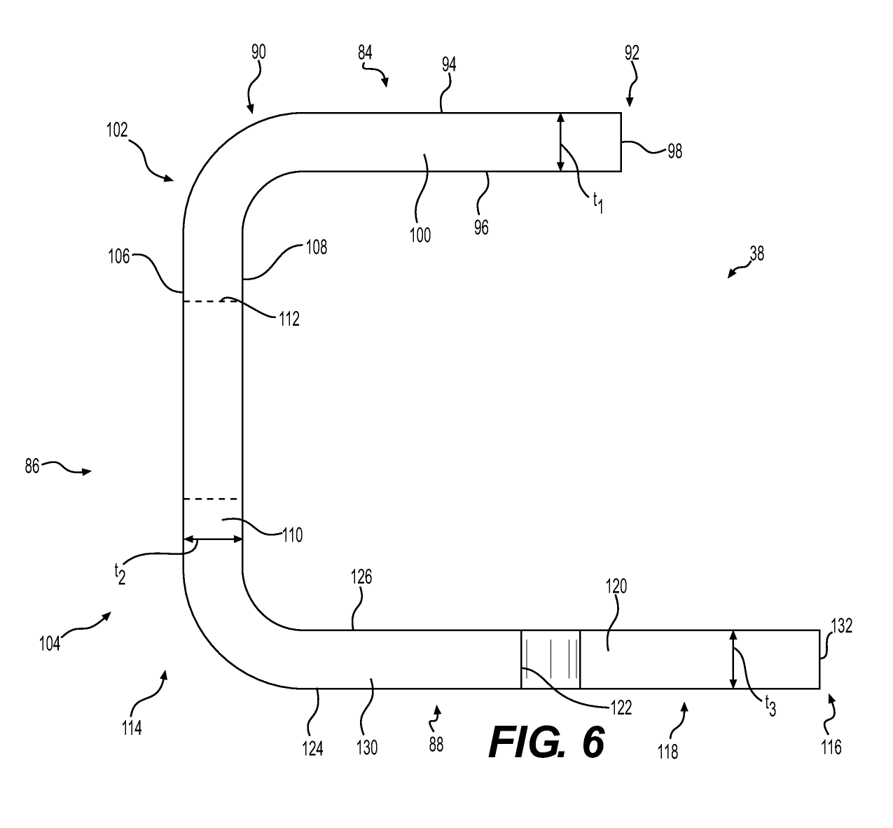

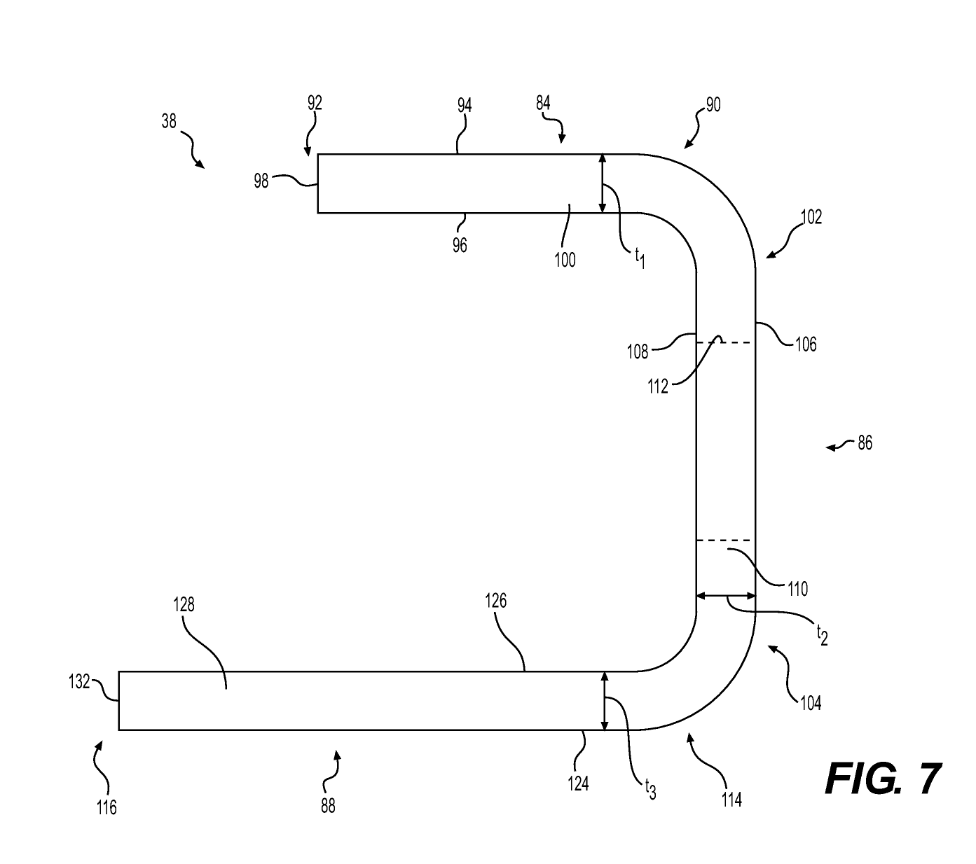

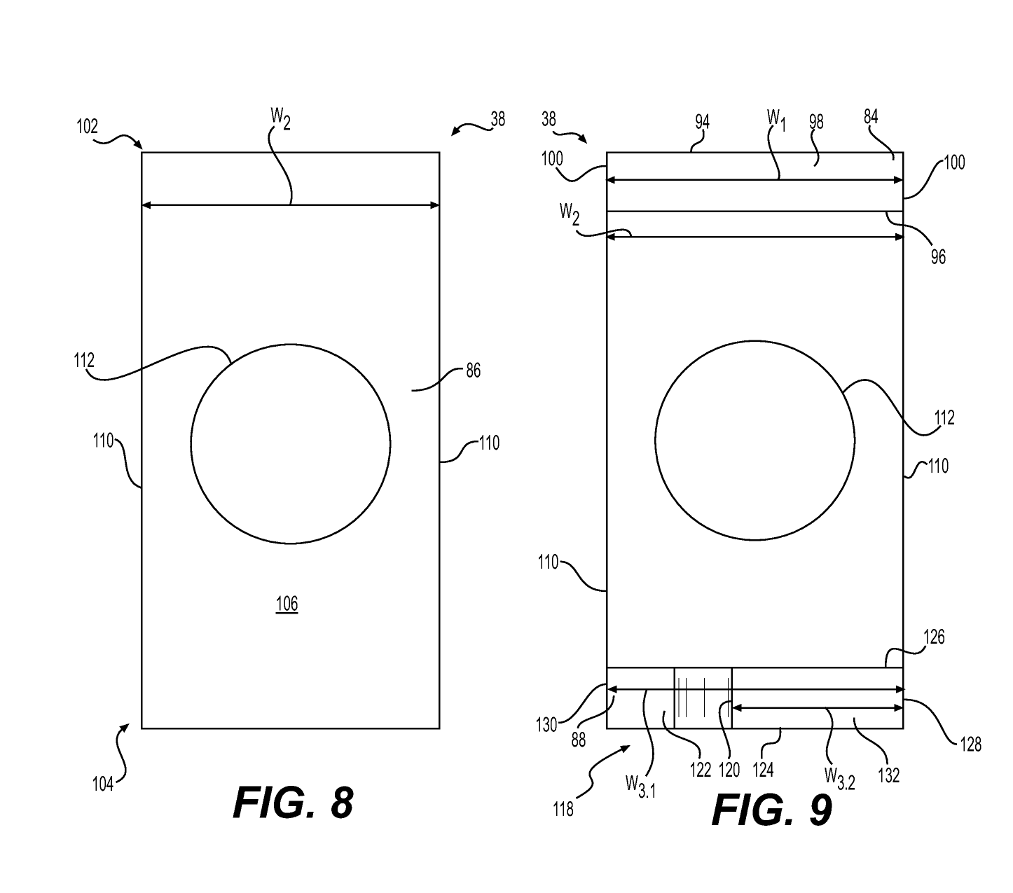

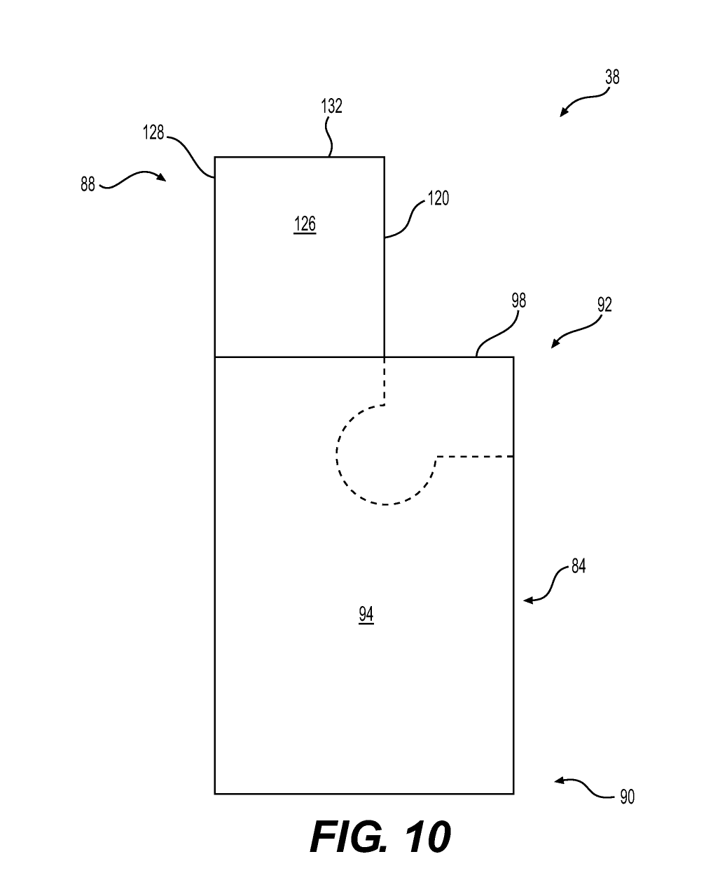

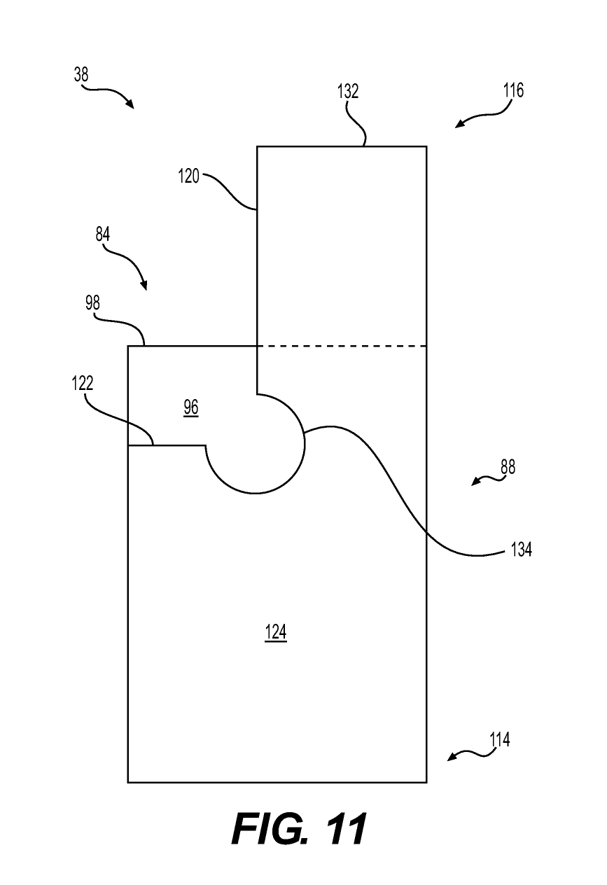

Referring next to FIG. 5-11, features of the bracket 38 are now described. The bracket 38 generally includes three legs: a first leg 84, a second leg 86, and a third leg 88. The first leg 84 and the third leg 88 are both connected with and extend from the second leg 86. The first leg 84 extends generally opposed from the third leg, so that the first and third legs 84, 88 are spaced from and in general facing relationship with each other. In the embodiment shown, the first leg 84 and the third leg 88 extend generally parallel with each other, and both extend generally perpendicular with the second leg 86.

The first leg 84 extends along a length between a proximal end 90 and a distal end 92. The proximal end 90 is located near where the first leg 84 is connected with the second leg 86. The distal end 92 is a free end and is configured to be received in one of the sockets 54, 76 when the bracket 38 is secured to the respective enclosure panel 34, 36.

The first leg 84 includes an outer surface 94, an inner surface 96, an end surface 98, and side surfaces 100. The outer surface 94 is generally opposed from the inner surface 96. The end surface 98 and the side surfaces 100 connect the outer surface 94 and the inner surface 96. The end surface 98 is positioned at the distal end 92 of the first leg 84, and the side surfaces 100 extend substantially along the length of the first leg 84 between the proximal end 90 and the distal end 92.

In the embodiment shown, the first leg 84 has a constant width w₁ from the proximal end 90 to the distal end 92 (the width being measured between the side surfaces 100). Also in the embodiment shown, the first leg 84 has a constant thickness t₁ from the proximal end 90 to the distal end 92 (the thickness being measured between the outer surface 94 and the inner surface 96).

The second leg 86 extends along a length between a first end 102 and a second end 104. The first end 102 is located near where the second leg 86 is connected with the first leg 84. The second end 104 is located near where the second leg 86 is connected with the third leg 88.

The second leg 86 includes an outer surface 106, an inner surface 108, and side surfaces 110. The outer surface 106 is generally opposed from the inner surface 108. The side surfaces 110 connect the outer surface 106 and the inner surface 108, and extend substantially along the length of the second leg 86 between the first end 102 and the second end 104. The inner surface 108 is located adjacent to the inner surface 96 of the first leg 84. The inner surface 108 is configured to face the front surface 44, 46 of a respective enclosure panel 34, 36 when the bracket 38 is secured to the enclosure panel 34, 36.

The second leg 86 also includes a bore 112 that extends from the inner surface 108 to the outer surface 106. The bore 112 is configured to receive a fastener, as will be described further below. As shown, the bore 112 is generally centrally located in the second leg 86, being positioned between the first end 102 and the second end 104, and between the side surfaces 110.

In the embodiment shown, the second leg 86 has a constant width w₂ from the first end 102 to the second end 104 (the width being measured between the side surfaces 110). Also in the embodiment shown, the second leg 86 has a constant thickness t₂ from the first end 102 to the second end 104 (the thickness being measured between the outer surface 106 and the inner surface 108).

The third leg 88 extends along a length between a proximal end 114 and a distal end 116. The proximal end 114 is located near where the third leg 88 is connected with the second leg 86. The distal end 116 is a free end. A notch 118 is formed in the third leg 88, and is defined by a first notch surface 120 and a second notch surface 122.

The third leg 88 includes an outer surface 124 and an inner surface 126, which are generally opposed from each other. The inner surface 126 is located adjacent to the inner surface 108 of the second leg 86, and is spaced from and generally faces the inner surface 96 of the first leg 84.

The third leg 88 also includes a first side surface 128, a second side surface 130, and an end surface 132. The first side surface 128 extends substantially along the length of the third leg 88 between the proximal end 114 and the distal end 116. The end surface 132 is positioned at the distal end 116. The second side surface 130 extends from the proximal end 114 toward the distal end 116, but terminates before reaching the distal end 116 (at the second notch surface 122). The second notch surface 122 extends inwardly from the second side surface 130 toward the first side surface 128, but terminates before reaching the first side surface 128 (at the first notch surface 120). The first notch surface 120 extends forwardly from the second notch surface 122 to the distal end 116. The end surface 132 extends between the first side surface 128 and the first notch surface 120. The first side surface 128, the second side surface 130, the first notch surface 120, the second notch surface 122, and the end surface 132 connect the outer surface 124 and the inner surface 126.

Optionally, the third leg 88 can include a rounded connecting surface 134 at the connection of the first notch surface 120 and the second notch surface 122. As shown, the rounded connecting surface 134 sweeps out a semi-circular pathway (approximately ¾ of a circle), when viewed from above. From the first notch surface 120, the rounded connecting surface 134 extends for approximately ¼ of a circle in a downward arc, toward the proximal end 114 and away from the second notch surface 122. The rounded connecting surface 134 continues extending downwardly for approximately ¼ of a circle toward the proximal end 114, but arcs back toward the second notch surface 122. The rounded connecting surface 134 then extends upwardly for approximately ¼ of a circle toward the distal end 116 and toward the second notch surface 122 until it reaches the second notch surface 122.

In the embodiment shown, and because of the notch 118, the third leg 88 does not have a constant width from the proximal end 114 to the distal end 116. Rather, the third leg 88 has a first width w_{3.1} near the proximal end 114 (the width being measured between the first side surface 128 and the second side surface 130), and a second width w_{3.2} near the distal end 116 (the width being measured between the first side surface 128 and the first notch surface 120). The first width w_{3.1} is greater than the second width w_{3.2}. Also in the embodiment shown, the third leg 88 has a constant thickness t₃ from the proximal end 114 to the distal end 116 (the thickness being measured between the outer surface 124 and the inner surface 126).

The first notch surface 120 is configured to be in contacting relationship with the outer surface 40, 62 of the respective enclosure panel 34, 36 when the bracket 38 is secured to an enclosure panel 34, 36. And the second notch surface 122 is configured to be in contacting relationship with the front surface 44, 66 of the respective enclosure panel 34, 36 when the bracket 38 is secured to an enclosure panel 34, 36.

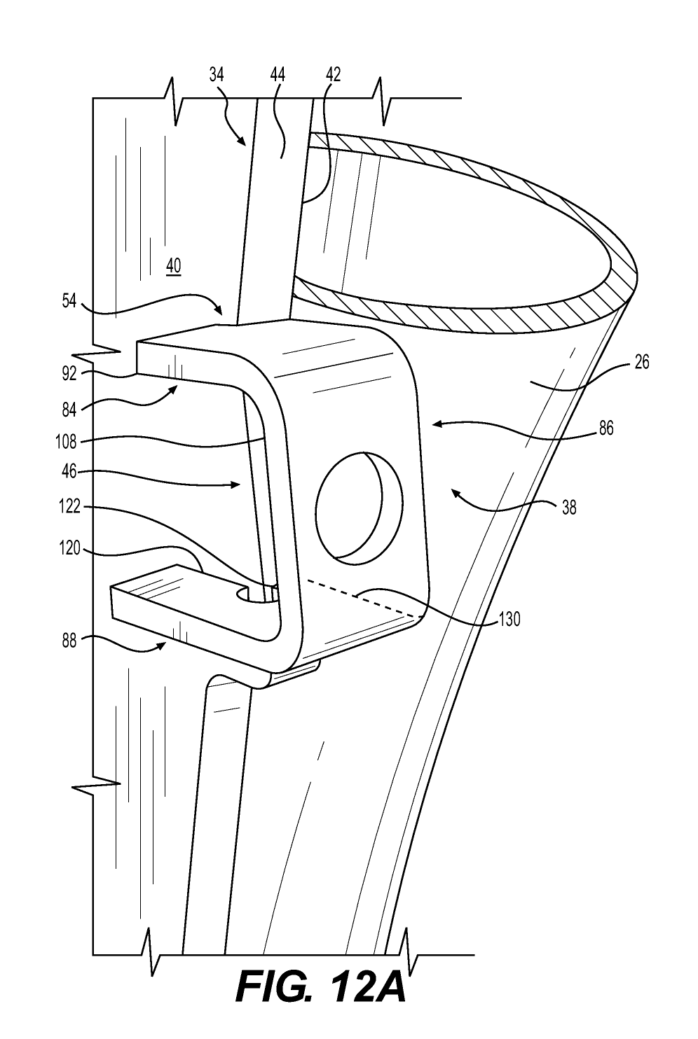

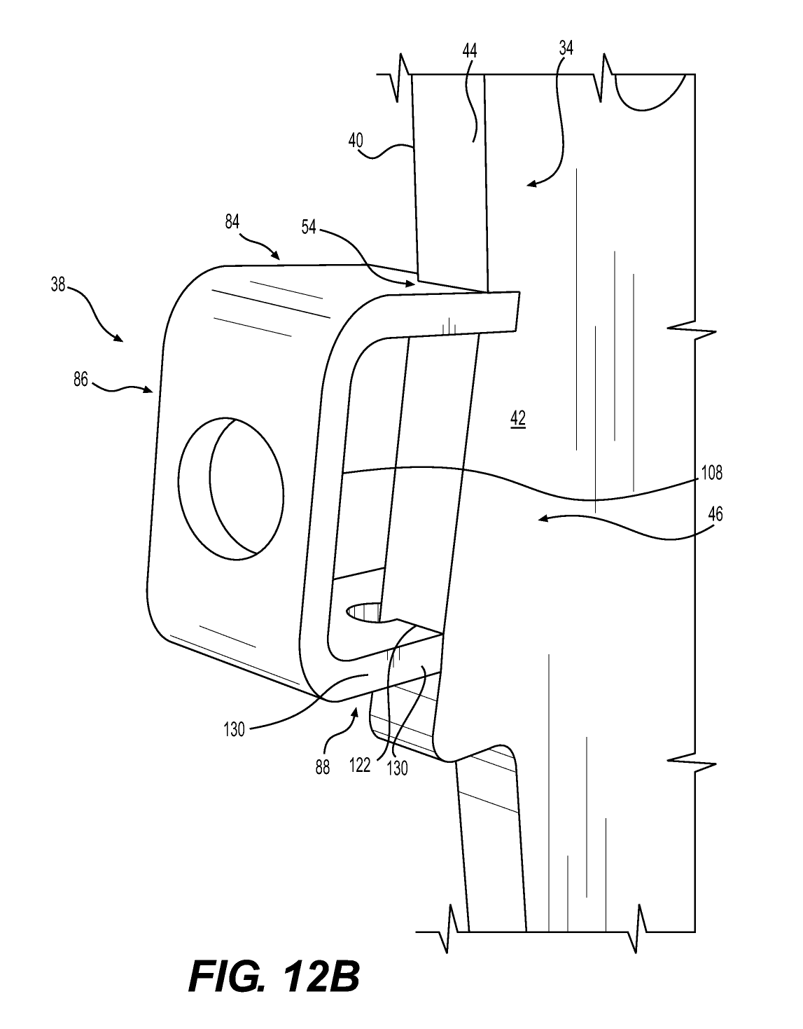

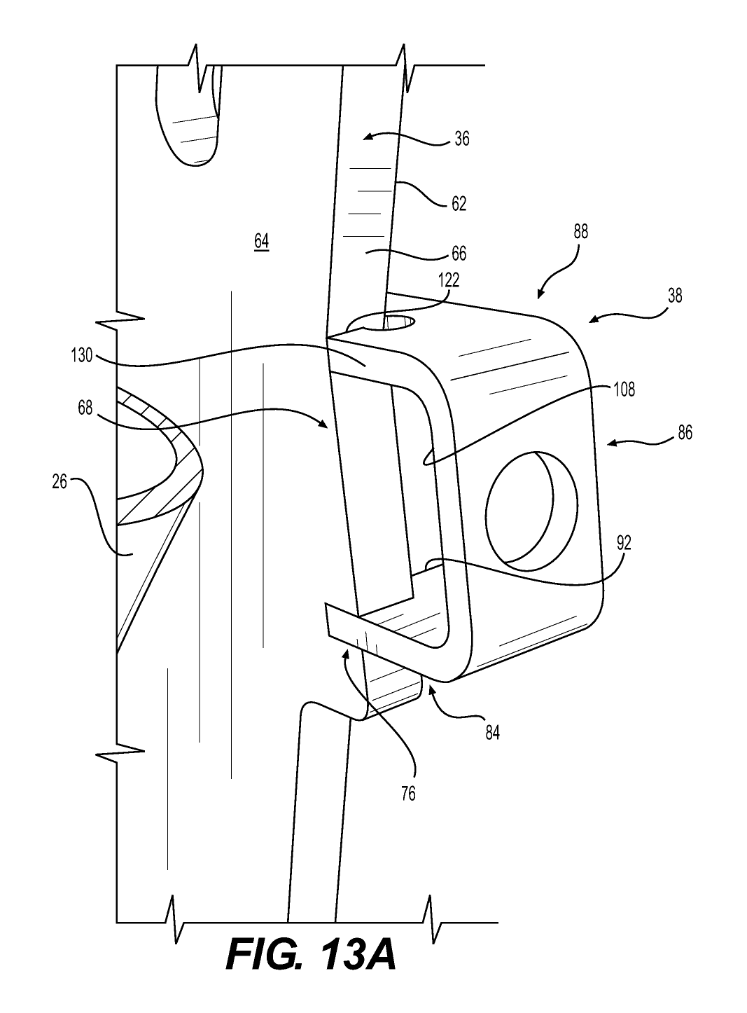

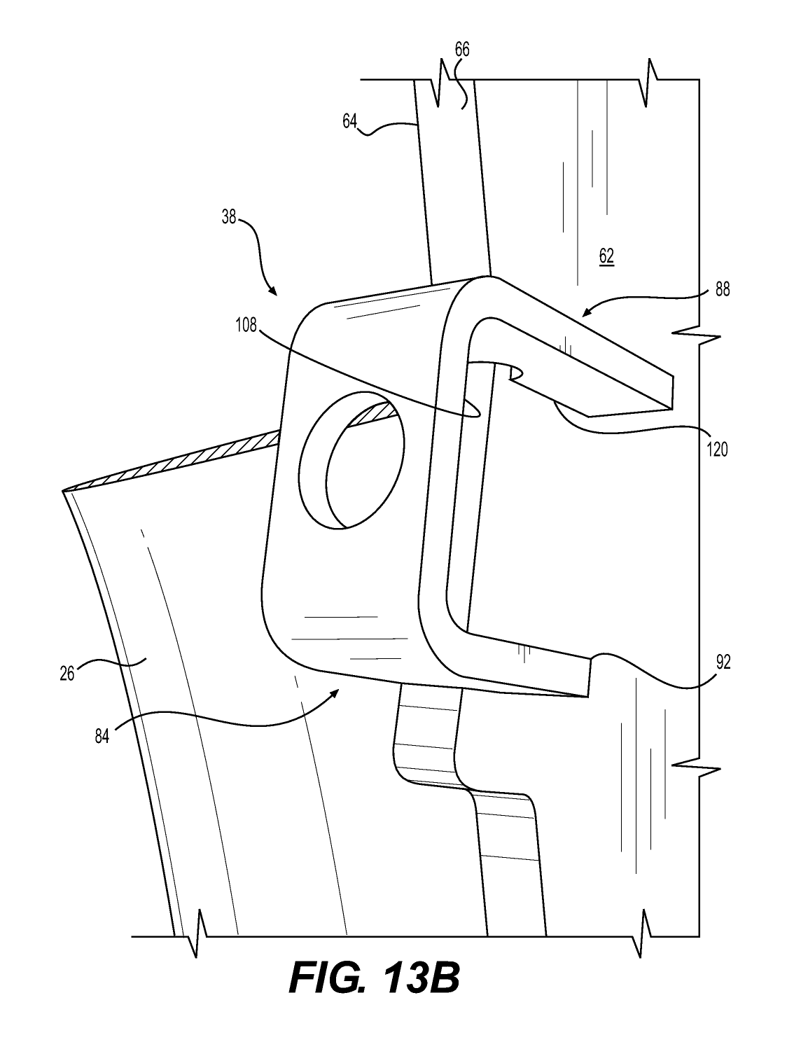

Securing a bracket 38 to the respective enclosure panels 34, 36 will now be described with reference to FIGS. 12A and 12B, and 13A and 13B, and beginning with the first enclosure panel 34 shown in FIGS. 12A and 12B.

The bracket 38 is brought into proximity with the mounting portion 46 of the first enclosure panel 34. The bracket 38 is oriented such that the first leg 84 is above the third leg 88.

The distal end 92 of the first leg 84 of the bracket 38 is positioned in the socket 54 of the first enclosure panel 34. In particular, the first leg 84 is inserted into the socket 54 such that the outer surface 94 of the first leg 84 faces and is adjacent to the first socket surface 78, and such that the inner surface 96 of the first leg 84 faces and is adjacent to the second socket surface 80. The end surface 98 of the first leg 84 faces the third socket surface 82, and the first leg 84 may be inserted into the socket 54 up to the point where the end surface 98 contacts the third socket surface 82. Advantageously, the first leg 84 and the socket 54 may be configured such that the first leg 84 is retained by the socket 54 when the first leg 84 is inserted into the socket 54. For example, once the distal end 92 of the first leg 84 is positioned in the socket 54, the bracket 38 is retained by the socket 54, making it unnecessary to further hold the bracket 38. Because the bracket 38 can be retained by the socket 54, a fixture for holding the bracket 38 in position is not required.

Positioning the distal end 92 of the first leg 84 in the socket 54 limits movement of the bracket 38 relative to the first enclosure panel 34 in a first direction (the up-down direction). In particular, the bracket 38 cannot be moved upwardly or downwardly with respect to the first enclosure panel 34 once the distal end 92 of the first leg 84 is positioned in the socket 54.

The second leg 86 of the bracket 38 is positioned in facing relationship with the front surface 44 of the first enclosure panel 34. In the embodiment shown, the inner surface 108 of the second leg 86 is spaced from the front surface 44.

The first notch surface 120 of the third leg 88 is positioned in contacting relationship with the outer surface 40 of the first enclosure panel 34. Positioning the first notch surface 120 in contacting relationship with the outer surface 40 limits movement of the bracket 38 relative to the first enclosure panel 34 in a second direction (the side-to-side direction). In particular, the bracket 38 cannot be moved further toward the steering column 26 once the first notch surface 120 contacts the outer surface 40.

The second notch surface 122 of the third leg 88 is positioned in contacting relationship with the front surface 44 of the first enclosure panel 34. Positioning the second notch surface 122 in contacting relationship with the front surface 44 limits movement of the bracket 38 relative to the first enclosure panel 34 in a third direction (the fore-aft direction). In particular, the bracket 38 cannot be moved further toward the first enclosure panel 34 once the second notch surface 122 contacts the front surface 44. In the embodiment shown, when the second notch surface 122 contacts the front surface 44, the inner surface 108 of the second leg 86 is spaced from the front surface 44.

Advantageously, the bracket 38 may be configured such that no portion of the bracket 38 extends beyond the inner surface 42 of the first enclosure panel 34. Additionally, the bracket 38 may be configured such that the second side surface 130 is aligned with the inner surface 42. For example, the dimensional characteristics of the bracket 38, including its legs 84, 86, 88, can be selected such that (1) no portion of the bracket 38 extends beyond the inner surface 42 when the first notch surface 120 contacts the outer surface 40 of the first enclosure panel 34, and/or (2) such that the second side surface 130 is aligned with the inner surface 42 when the first notch surface 120 contacts the outer surface 40 of the first enclosure panel 34. For example, and as shown, bracket 38 is configured such that the second side surface 130 is substantially aligned with the inner surface 42 when the first notch surface 120 contacts the outer surface 40 of the first enclosure panel 34.

Thereby, the bracket 38 may be secured to the first enclosure panel 34 in such a manner that: (1) prevents any portion of the bracket 38 from extending beyond the inner surface 42, or (2) aligns the second side surface 130 of the third leg 88 with the inner surface 42.

The bracket 38 may be welded to, or otherwise permanently or semi-permanently secured to, the first enclosure panel 34. For example, after positioning the distal end 92 of the first leg 84 in the socket 54, after positioning the second leg 86 in facing relationship with the front surface 44, after positioning the first notch surface 120 in contacting relationship with the outer surface 40, and after positioning the second notch surface 122 in contacting relationship with the front surface 44, the bracket 38 can be welded to the first enclosure panel 34. In addition to welding, other techniques for permanently or semi-permanently securing the bracket 38 to the first enclosure panel 34 may also be used, such as using adhesives.

Securing a bracket 38 to the second enclosure panel 36 is substantially similar to what has been described for the first enclosure panel 34, except that the bracket 38 is oriented such that the third leg 88 is above the first leg 84, as shown in FIGS. 13A and 13B. The distal end 92 of the first leg 84 is positioned in the socket 76 of the second enclosure panel 36. Advantageously, the first leg 84 and the socket 76 may be configured such that the first leg 84 is retained by the socket 76 when the first leg 84 is inserted into the socket 76.

The second leg 86 of the bracket 38 is positioned in facing relationship with the front surface 66. The first notch surface 120 is positioned in contacting relationship with the outer surface 62, and the second notch surface 122 is positioned in contacting relationship with the front surface 66.

The bracket 38 may be secured to the second enclosure panel 36 in such a manner that: (1) prevents any portion of the bracket 38 from extending beyond the inner surface 64, or (2) aligns the second side surface 130 of the third leg 88 with the inner surface 64. The bracket 38 may be welded to, or otherwise permanently or semi-permanently secured to, the second enclosure panel 36.

As shown in FIG. 3, the first and second instrument panels 28, 30 are each respectively secured to the first and second enclosure panels 34, 36 via a bracket 38. In particular, a fastener 136 secures the first instrument panel 28 to the bracket 38 secured to the first enclosure panel 34, and a similar fastener 136 secures the second instrument panel 30 to the bracket 38 secured to the second enclosure panel 36. For example, the fasteners 136 are inserted into the bores 112 of the respective brackets 38. Because the second legs 86 of the brackets 38 are spaced from the front surfaces 44, 66 of the respective enclosure panels 34, 36, the fasteners 136 can be inserted through the bores 112 and received in the space between the second legs 86 and the front surfaces 44, 66.

### INDUSTRIAL APPLICABILITY

Machines often have cab assemblies that include within them machine controls. Such machine controls may be situated in, or be associated with, instrument panels. The instrument panels are secured to an underlying support structure. As described above, the first and second instrument panels 28, 30 are secured to first and second enclosure panels 34, 36 of a steering column enclosure assembly 32 via brackets 38. In particular, a bracket 38 is secured to each of the first and second enclosure panels 34, 36. The first and second instrument panels 28, 30 are secured to respective brackets 38 by fasteners 136.

Thereby, the brackets 38 provide a structure for mounting a piece to a panel. The brackets 38 cooperate with the outer surfaces 40, 62 and the front surfaces 44, 66, and with sockets 54, 76. Advantageously, the brackets 38 are retained by the sockets 54, 76, and an additional fixture for holding the brackets 38 is not required. Moreover, the sockets 54, 76 provide locations where the brackets 38 can be repeatedly placed on the first and second enclosure panels 34, 36.

As discussed above, the distal end 92 of the first leg 84 is positioned in the socket 54, 76 of the first and second enclosure panels 34, 36. The second leg 86 is positioned in facing relationship with the front surface 44, 66 of the first and second enclosure panels 34, 36. The first notch surface 120 is positioned in contacting relationship with an outer surface 40, 62 of the first and second enclosure panels 34, 36, and the second notch surface 122 is positioned in contacting relationship with the front surface 44, 66 of the first and second enclosure panels 34, 36. The first and second instrument panels 28, 30 may then each be secured to the first and second enclosure panels 34, 36, such as via a bracket 38.

While the machine 10 shown is in the form of a mining truck, it will be appreciated that this disclosure is also applicable to other types of machines, as well. In addition, while the brackets 38 were shown working with panels of a steering column enclosure assembly 32, the brackets 38 might also be used in association with other types of panels.

It will be appreciated that the foregoing description provides examples of the disclosed bracket, assembly, and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure unless specifically indicated.

What is claimed is:

1. A bracket for securing to a panel having an outer surface, an inner surface generally opposed from the outer surface, a front surface connecting the outer surface and the inner surface, and a socket, the bracket comprising:
a first leg having a proximal end and a distal end, the distal end being configured to be received in the socket of the panel to limit movement of the bracket with respect to the panel in a first direction,
a second leg connected with the first leg, and
a third leg connected with the second leg and extending generally opposed from the first leg, the third leg including a first notch surface and a second notch surface, the first notch surface being configured to be in contacting relationship with the outer surface of the panel to limit movement of the bracket with respect to the panel in a second direction different from the first direction, and the second notch surface being configured to be in contacting relationship with the front surface of the panel to limit movement of the bracket with respect to the panel in a third direction different from the first direction and the second direction.

2. The bracket of claim 1, the first leg, second leg, and third leg being configured such that no part of the bracket extends beyond the inner surface of the panel when the first notch surface is in contacting relationship with the outer surface of the panel.

3. The bracket of claim 1, the third leg having an inner surface facing the first leg, an outer surface generally opposed from the inner surface, and a side surface connecting the inner surface and the outer surface, the first leg, second leg, and third leg being configured such that the side surface of the third leg is substantially aligned with the inner surface of the panel when the first notch surface is in contacting relationship with the outer surface of the panel.

4. The bracket of claim 1, the second leg including an inner surface, and the first leg, second leg, and third leg being configured such that the inner surface of the second leg faces and is spaced from the front surface of the panel when the second notch surface is in contacting relationship with the front surface of the panel.

5. The bracket of claim 1, the first leg and the third leg extending generally parallel with each other.

6. The bracket of claim 1, the second leg extending generally perpendicular with the first leg and the third leg.

7. The bracket of claim 1, the second leg including an inner surface, an outer surface, and a bore extending from the inner surface to the outer surface.

8. The bracket of claim 1, the third leg further including a rounded connecting surface between the first notch surface and the second notch surface.

9. An assembly, comprising:
a panel having an outer surface, an inner surface generally opposed from the outer surface, a front surface connecting the outer surface and the inner surface, and a socket, and
a bracket secured to the panel, the bracket including:
a first leg having a proximal end and a distal end, the distal end being received in the socket of the panel and limiting movement of the bracket with respect to the panel in a first direction,
a second leg connected with the first leg, and
a third leg connected with the second leg and extending generally opposed from the first leg, the third leg including a first notch surface and a second notch surface, the first notch surface being in contacting relationship with the outer surface of the panel and limiting movement of the bracket with respect to the panel in a second direction different from the first direction, and the second notch surface being in contacting relationship with the front surface of the panel and limiting movement of the bracket with respect to the panel in a third direction different from the first direction and the second direction.

10. The assembly of claim 9, wherein no part of the bracket extends beyond the inner surface of the panel.

11. The assembly of claim 9, the third leg having a side surface that is substantially aligned with the inner surface of the panel.

12. The assembly of claim 9, the second leg including an inner surface facing and spaced from the front surface of the panel.

13. The assembly of claim 9, the second leg including an inner surface facing the inner surface of the panel, an outer surface generally opposed from the inner surface, and a bore extending from the inner surface to the outer surface.

14. The assembly of claim 13, further comprising:
an instrument panel, and
a fastener securing the instrument panel to the panel and being received in the bore of the bracket.

15. The assembly of claim 9, wherein the bracket is welded to the panel.

16. The assembly of claim 9, further comprising:
a steering column enclosure assembly, the steering column enclosure assembly including the panel.

17. A method of securing a three-legged bracket to a panel having an outer surface, an inner surface generally opposed from the outer surface, a front surface connecting the outer surface and the inner surface, and a socket, the method comprising:
positioning a distal end of a first leg of the bracket in the socket of the panel,
positioning a second leg of the bracket in facing relationship with the front surface of the panel,
positioning a first notch surface of a third leg of the bracket in contacting relationship with the outer surface of the panel, and
positioning a second notch surface of the third leg of the bracket in contacting relationship with the front surface of the panel.

18. The method of claim 17, further comprising:
preventing any portion of the bracket from extending beyond the inner surface of the panel.

19. The method of claim 17, further comprising:
aligning a side surface of the third leg of the bracket with the inner surface of the panel.

20. The method of claim 17, further comprising:
welding the bracket to the panel.
